(19) United States
(12) Patent Application Publication
(10) Pub. No.: US 2004/0248510 A1
(43) Pub. Date: Dec. 9, 2004

(54) Method and apparatus for removing spinal cord

(75) Inventors: Shiro Ono, Kagoshima (JP); Koji Kusumoto, Kagoshima (JP)

Correspondence Address: MARSHALL, GERSTEIN & BORUN LLP, 6300 SEARS TOWER, 233 S. WACKER DRIVE, CHICAGO, IL, 60606, US

(73) Assignee: ITOHAM FOODS INC., Hyogo (JP)

(21) Appl. No.: 10/832,140

(22) Filed: Apr. 26, 2004

(30) Foreign Application Priority Data
Apr. 15, 2002 (JP) 2002-111491
Dec. 7, 2001 (JP) 2001-373864

(51) Int. Cl. A22C 18/00

(52) U.S. Cl. 452/155

(57) ABSTRACT

An apparatus for removing spinal cord of cattle in a short time without reducing a commercial value of meat and while inhibiting contamination, comprises a first nozzle 3 and a second nozzle 4 adapted to be inserted into a spinal cavity of the slaughtered cattle to suction the spinal cord, a detector 30 configured to detect size of the carcass of the slaughtered cattle, a first presser 21 configured to press one of a dorsal part and a thoracic part of the carcass of the slaughtered cattle, and a second presser 22 configured to press the other part, and the first and second pressers 21 and 22 are configured to, in response to a detection signal detected by the detector 30, move up and down by a distance corresponding to the detection signal to press predetermined proper parts of the carcass.

### BACKGROUND OF THE INVENTION

1. Field of the Invention

The present invention relates to a method and apparatus for removing spinal cord from a carcass of slaughtered cattle, and more particularly to a method and apparatus for removing spinal cord from a spinal cavity of beef cattle or the like.

2. Description of the Related Art

In recent years, various examples of diseases caused by abnormal prion proteins (hereinafter also referred to as prion diseases) have been reported, among which bovine spongiform encephalopathy (BSE) (generally called mad cow disease), or scrapie of sheep and goat are representative. The prion diseases are progressive nerve system diseases. Cattle is infected by abnormal prion proteins by biosynthesis or ingestion. Brain tissues of the cattle are destroyed by the abnormal prion proteins accumulated in brain or nerve. And finally, the brain of the cattle is denatured in the form of sponge, which brings about the infective cattle death.

It has been believed that infectivity by the abnormal prion proteins is not substantially affected by heating sterilization, irradiation sterilization, or drug solution sterilization, unlike in the microbes such as virus or bacteria, which are causes of general infective diseases. Therefore, in order to prevent infection by the abnormal prion proteins, it is essential that ingestion of such abnormal prion proteins into a body, for example, by eating them, be avoided. These days, in Japan, in order to prevent infection with Creutzfeid-Jacob disease (CJD) from the beef cattle being infected with the BSE, tests are carried out to confirm beef cattle's infection, and suspicious beef cattle are incinerated according to regulations. After the tests, only the beef cattle which do not possess abnormal prion proteins are slaughtered or butchered and dissected.

It has been confirmed that in the cattle infected with the prion diseases, the abnormal prion proteins unevenly exist in brain, spinal cord, eyes, or intestinum ileum distal parts, which are specified as dangerous parts. So, by way of precaution, efforts are being directed to improving safety by completely removing the dangerous parts of even the beef cattle that have passed the above-stated tests.

The cattle is typically dissected and made into meat products through the process: slaughtering the cattle and letting the cattle bleed, removing bone, hoof, tail part, and so forth, tearing off skin, cutting off head, splitting thoracic part, removing visceral organs, splitting dorsal part to produce dressed carcass, cooling, removing bone, and dividing. Among the dangerous parts, the brain, the eyes, and the intestinum ileum distal parts can be removed relatively easily without contaminating operators or parts to be eaten by cutting off the head and removing the visceral organs. However, there is a possibility that the spinal cord scatters and contaminates the parts to be eaten or the operators when the spinal cord is scraped after the dorsal part is split.

In view of the above, it is desirable to remove the spinal cord before splitting the dorsal part. Accordingly, there has been proposed to push out the spinal cord from the head part by feeding air under high pressure from lumbar part. However, in this method, the parts to be eaten are crushed into pieces or damaged by the high air pressure. This reduces a commercial value of the meat. Further, the spinal cord tends to scatter by the application of the air pressure, which probably contaminates floor of work area.

### SUMMARY OF THE INVENTION

Under the circumstances, the present invention has been developed, and an object of the present invention is to provide a method and apparatus for removing spinal cord from cattle while inhibiting contamination and keeping a commercial vale of meat of the cattle.

Intensive studies of spinal cord removal in treatment of cattle have been conducted with a view to achieving the above object.

According to the present invention, there is provided a method of removing spinal cord, comprising the step of: after letting a carcass of slaughtered cattle bleed, removing a tail part from the carcass, cutting off a head from the carcass, and tearing off skin from the carcass, removing the spinal cord from a spinal cavity by inserting a suction nozzle from a head side of the carcass into the spinal cavity to suction the spinal cord within the spinal cavity. In accordance with this method, the spinal cord can be removed from the cattle such as beef cattle, pig, and sheep while inhibiting contamination and keeping a commercial value of the meat.

In the above method, it is preferable that the cattle is beef cattle, and the step of removing the spinal cord may include a first step of inserting a first suction nozzle to a terminal end part of a tail side of lumbar vertebrae to suction the spinal cord; and a second step of inserting a second suction nozzle to a terminal end part of a tail side of sacral vertebrae to suction the spinal cord, the second suction nozzle having an outer diameter smaller than an outer diameter of the first suction nozzle. In the case of the cattle having a relatively large size, such as the beef cattle, the spinal column is long and the spinal cavity has a cross-sectional area varying greatly from a head part to a tail part. When using a single suction nozzle having a small outer diameter that reaches a terminal end of the tail part to suction the spinal cord, it is difficult to remove the spinal cord sufficiently. In accordance with the present invention, accordingly, by using two types of suction nozzles, suction is carried out in two steps, i.e., the spinal cord is removed from a region of the spinal cavity having a relatively large inner diameter and a region of the spinal cavity having a relatively small inner diameter. In this manner, removal of the spinal cord is facilitated.

The method may further comprise the step of: substantially straightening spinal column by pressing the head side of the carcass to reduce a curvature of the spinal column, when the suction nozzle is inserted into the spinal cavity. By doing so, the curved spinal column is made as straight as possible to allow the suction nozzle to be easily inserted into the spinal cavity. Thereby, removal of the spinal cord is facilitated.

It is preferable that the step of substantially straightening the spinal column is performed by using a press member and a support member. In accordance with this method, the step of substantially straightening the spinal column is reliably and easily performed.

According to the present invention, there is also provided an apparatus for removing spinal cord comprising a suction nozzle adapted to be inserted into a spinal cavity of a carcass of slaughtered cattle to suction spinal cord within the spinal cavity. After letting the carcass of the slaughtered cattle bleed, removing the tail part, cutting off the head, and tearing off the skin, the suction nozzle is inserted into the spinal cavity while suctioning the spinal cord, thus removing the spinal cord from the spinal cavity.

It is preferable that the apparatus may further comprise a press-member configured to press a head side of a dorsal part of the carcass to reduce a curvature of spinal column; and a support member configured to support a thoracic part of the carcass. The press member and the support member enable the curved spinal column to be substantially straightened when the suction nozzle is inserted in the above method, thus facilitating removal of the spinal cord. As used herein, “thoracic part of the carcass” includes thoracic part of vertebrae.

It is preferable that the suction nozzle includes a first nozzle and a second nozzle, and the first nozzle is larger in diameter than the second nozzle. By using two types of suction nozzles, suction is carried out in two steps, i.e., the spinal cord is removed from a region of the spinal cavity having a relatively large inner diameter and a region of the spinal cavity having a relatively small inner diameter. In this manner, removal of the spinal cord is facilitated.

It is preferable that the first suction nozzle has an outer diameter of 14 mm and the second suction nozzle has an outer diameter of 11 mm. By using the two types of suction nozzles, insertion of the nozzles into the spinal cavity of normal beef cattle, and suction and removal of the spinal cavity are facilitated.

The apparatus may further comprise a detector configured to detect a size of the carcass of the slaughtered cattle; a first presser configured to press one of the dorsal part and the thoracic part of the carcass of the slaughtered cattle; and a second presser configured to press the other part, wherein at least one of the first and second pressers is movable up and down. The first and second pressers press the curved spinal column of the carcass from the dorsal side and the thoracic side, respectively to substantially straighten the curved vertebrae. Thereby, the nozzle for suctioning the spinal cord is easily inserted into the spinal cavity. Since the first and second pressers are moved up and down according to the size of the carcass detected by the detector, the first and second pressers are opposed to each other at proper parts of the carcass to be pressed.

One of the pressers may be fixed and the other presser may be operated to press the carcass. In this case, the dorsal side or the thoracic side of the spinal column of the carcass may be supported by the fixed presser, and the pressing force as a reactive force against the pressing operation by the other presser is applied to the carcass from the fixed presser.

It is preferable that at least one of the first and second pressers is configured to, in response to a detection signal detected by the detector, move up and down by a distance corresponding to the detection signal. Thereby, the first and second pressers can be automatically opposed to each other at proper parts of the carcass to be pressed, according to the size of the carcass.

It is preferable that a vertical position of at least one of the first and second pressers is adjustable by an operation performed by an operator. Thereby, the first and second pressers can be opposed to each other at proper parts of the carcass to be pressed, according to the size of the carcass, and such adjustment is finely made by an operation performed by an operator.

It is preferable that the apparatus may further comprise a detector configured to detect a size of the carcass of the slaughtered cattle; a first presser configured to press one of the dorsal part and the thoracic part of the carcass of the slaughtered cattle; a second presser configured to press the other part; and an up and down work table on which the first and second pressers are mounted. In accordance with this construction, the curved spinal column of the carcass of the slaughtered carcass can be suitably straightened as in the apparatus described above. In addition, since the work table is movable up and down according to the size of the carcass detected by the detector, the first and second pressers can be opposed to each other at proper parts of the carcass to be pressed.

One of the pressers may be fixed and the other presser may be operated to press the carcass. In this case, the dorsal side or the thoracic side of the spinal column of the carcass may be supported by the fixed presser, and the pressing force as a reactive force against the pressing operation by the other presser is applied to the carcass from the fixed presser.

It is preferable that the work table is configured to, in response to the detection signal detected by the detector, move up and down by a distance corresponding to the detection signal. Thereby, the first and second pressers can be automatically opposed to each other at proper parts of the carcass to be pressed, according to the size of the carcass.

It is preferable that a vertical position of the work table is adjustable by an operation performed by an operator. Thereby, the first and second pressers can be opposed to each other at proper parts of the carcass to be pressed, according to the size of the carcass, and fine adjustment is possible.

It is preferable that the apparatus is constructed such that at least one of the first and second pressers is movable relative to the carcass along a length of the carcass. Thereby, the first and second pressers can be opposed to each other at proper parts of the carcass to be pressed, according to the size of the carcass.

The apparatus may further comprise: a suspension device configured to suspend the carcass of the slaughtered cattle, the suspension device having a holding portion adapted to hold the carcass of the slaughtered cattle, wherein the detector has a plurality of detecting portions respectively provided at positions spaced predetermined distances apart from the holding portion. Thereby, the size of the carcass can be easily detected in a simple configuration.

It is preferable that the apparatus is constructed such that at least one of the first and second pressers is vertically pivotable to vary a press direction. Thereby, the pressers can press the carcass in a proper direction according to the shape of the carcass.

The above and further objects and features of the invention will more fully be apparent from the following detailed description with accompanying drawings.

### BRIEF DESCRIPTION OF THE DRAWINGS

FIG. 1 is a view showing a method and apparatus for removing spinal cord according to an embodiment of the present invention;

FIG. 2 is a cross-sectional view of a carcass of beef cattle;

FIG. 3A is a schematic view showing an entire structure of a suction nozzle in the spinal cord removing apparatus in FIG. 1;

FIG. 3B is a cross-sectional view of the suction nozzle;

FIG. 3C is a cross-sectional view of the suction nozzle;

FIG. 4 is a schematic view showing how to use a press member and a support member in the spinal cord removing apparatus in FIG. 1;

FIG. 5A is a perspective view of the press member in the spinal cord removing apparatus according to the embodiment of the present invention;

FIG. 5B is a rear view of the press member in FIG. 5A;

FIG. 5C is a plan view of the press member in FIG. 5A;

FIG. 6A is a perspective view of the support member in the spinal cord removing apparatus according to the embodiment of the present invention;

FIG. 6B is a side view of the support member in FIG. 6A;

FIG. 6C is a front view of the support member in FIG. 6A;

FIG. 7 is a perspective view showing an example of the spinal cord removing apparatus of the present invention;

FIG. 8 is a side view showing a procedure for substantially straightening curved spinal column of a carcass of the slaughtered cattle by the spinal cord removing apparatus in FIG. 7;

FIG. 9 is a side view showing an operation of a detector in the spinal cord removing apparatus in FIG. 7;

FIG. 10 is a perspective view showing another embodiment of the spinal cord removing apparatus of the present invention; and

FIG. 11 is a timing chart showing a spinal cord removing process performed by the spinal cord removing apparatus of the present invention.

### DETAILED DESCRIPTION OF THE PREFERRED EMBODIMENTS

Hereinafter, an embodiment of the present invention will be described with reference to the drawings. The present invention is not intended to be limited to this embodiment.

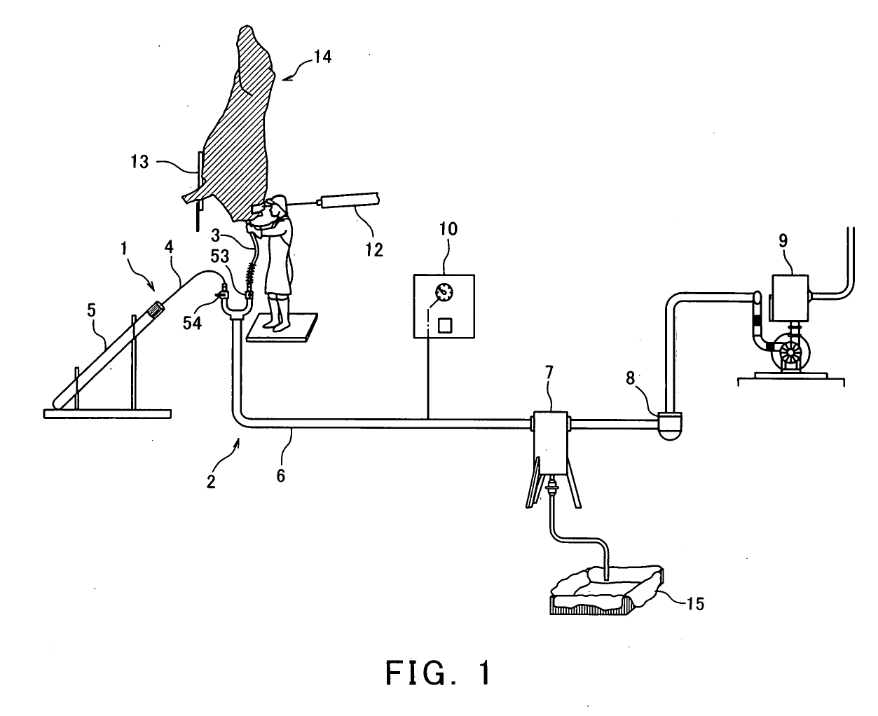

FIG. 1 schematically shows a spinal cord removing apparatus of the present invention. As shown in FIG. 1, a spinal cord removing apparatus 1 comprises a first nozzle 3 and a second nozzle 4 which are inserted into a spinal cavity of a carcass of slaughtered cattle to suction and remove spinal cord, a nozzle sterilization container 5 adapted to sterilize these nozzles 3 and 4 after use, a suction unit 2 respectively connected to the nozzles 3 and 4 through cocks 53 and 54, a collecting container 15 into which the suctioned spinal cord is collected, and a press member 12 and a support member 13 adapted to substantially straighten curved spinal column to allow the nozzles 3 and 4 to be smoothly inserted into the spinal cavity. The suction unit 2 includes a vacuum pipe 6, and a vacuum tank 7, a vacuum filter 8, a vacuum pump 9, and a meter 10 which are connected to the vacuum pipe 6.

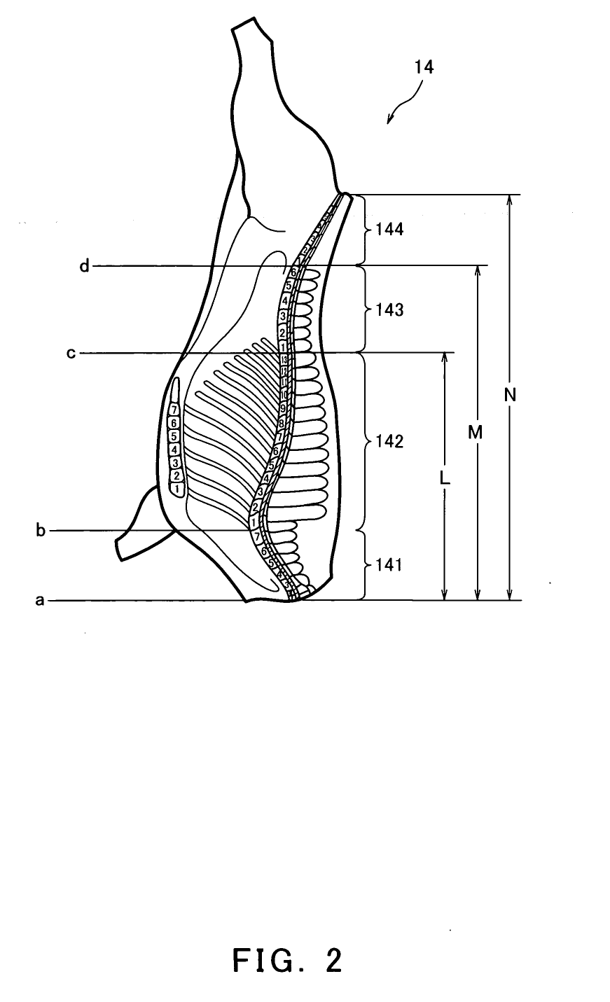

In FIG. 1, a carcass 14 is a warm carcass of the beef cattle obtained through the process: slaughtering the beef cattle by using a knocking pen or the like, letting the beef cattle bleed from carotid artery, removing bone, hoof, tail part, and so forth, tearing off skin of the carcass from tip end side of hind leg, cutting off head, and cutting out thoracic part to remove visceral organs. The spinal column (vertebral column) of the carcass 14 is, as shown in FIG. 2, composed of first to seventh cervical vertebrae (141 in FIG. 2), first to thirteenth thoracic vertebrae (142), first to sixth lumbar vertebrae (143), and first to fifth sacral vertebrae (144). From surveys of several examples of standard beef cattle, it has been found that an inner diameter of the cavity of the first cervical vertebra in a part represented by a is within a range of about 2.7 to 3.1 cm, an inner diameter of the cavity of the first thoracic vertebra in a part represented by b is within a range of about 2.0 to 2.3 cm, an inner diameter of the cavity of the first lumbar vertebra in a part represented by c is within a range of about 1.7 to 2.0 cm, and an inner diameter of the cavity of the first sacral vertebra in a part represented by d is within a range of about 1.9 to 2.1 cm. A length L from a head side of the first cervical vertebra to a tail side of the thirteenth thoracic vertebra is within a range of about 110 to 130 cm, a length M from the head side of the first cervical vertebra to a tail side of the sixth lumbar vertebra is about 145 to 165 cm, and a length N from the head side of the first cervical vertebra to the fifth sacral vertebra is about 175 to 200 cm.

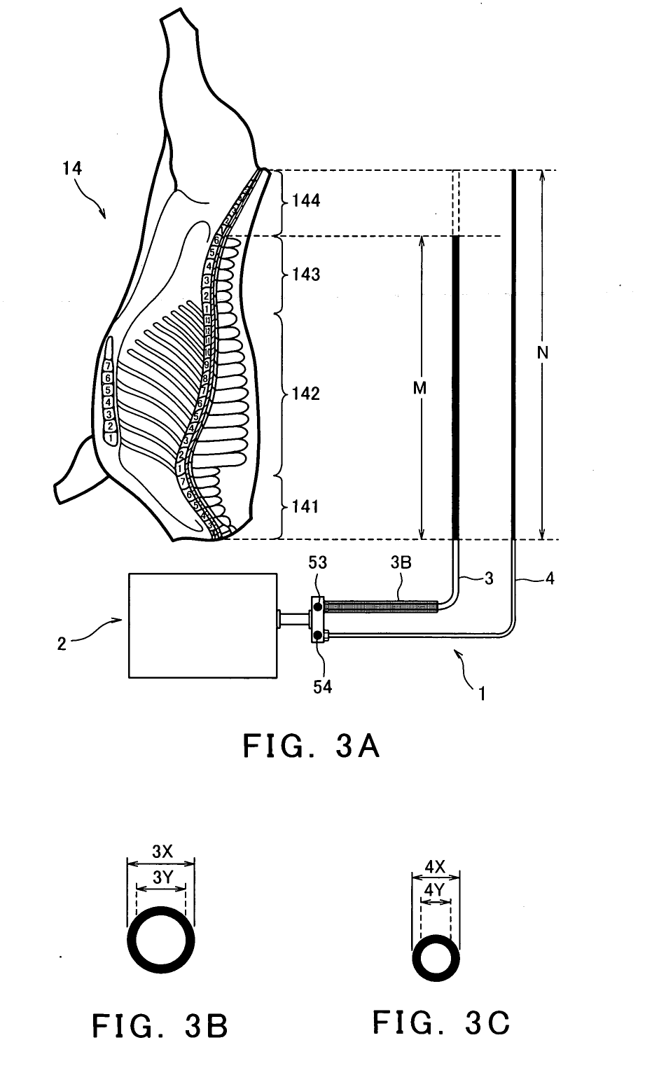

Considering the above-mentioned shape of the spinal column of the beef cattle, the carcass is suspended and the spinal cord is suctioned and removed from the suspended carcass 14 by the spinal cord removing apparatus in FIG. 1. First of all, the first nozzle 3 in FIG. 3A is inserted from the head side into the spinal cavity to reach the tail side of the sixth lumbar vertebra, i.e., over the length M=about 145 to 165 cm, while suctioning the spinal cord. At this time, the cock 53 is opened to drive the suction unit 2, which suctions the spinal cord under a negative pressure of 12 to 15 in Hg (mercurial column) (first step). The first nozzle 3 has a cross-section in FIG. 3B. An outer diameter 3×of the first nozzle 3 is set to preferably 12 to 17 mm, and more preferably 15 mm. An inner diameter 3Y of the first nozzle 3 is set to preferably 9 to 15 mm, and more preferably 12 mm. After collecting the spinal cord into the collecting container 15 as much as possible, the first nozzle 3 is pulled out from the spinal cavity. Then, the cock 53 is closed and the cock 54 is opened. Under this condition, the second nozzle 4 is inserted to a tail-side terminal end part corresponding to the fifth sacral vertebra, i.e., over the length of N=about 175 to 200 cm while suctioning the spinal cord under a negative pressure of 12 to 15 in Hg, thereby collecting all the spinal cord in the same manner (second step). The second nozzle 4 has a cross-section in FIG. 3C. An outer diameter 4X of the second nozzle 4 is set to preferably 9 to 14 mm, and more preferably 11 mm, and an inner diameter 4Y of the second nozzle 4 is set to preferably 5 to 10 mm, and more preferably 7 mm.

The nozzles 3 and 4 are made of a material having flexibility and strength, preferably Teflon (R), polyethylene, etc, and more preferably Teflon (R).

As shown in FIG. 3A, a flexible cover 3B is provided on an outer periphery of the first nozzle 3 on the side where the first nozzle 3 is connected to the cock 53 to reinforce the first nozzle 3. As a matter of course, such a cover may be provided on the second nozzle 4 as well.

Alternatively, insertion portions of the first and second nozzles 3 and 4 into the spinal cavity may be manufactured from the above-mentioned material, and removably attached to tubes manufactured from a material with high strength for the purpose of reinforcement, and the tubes may be connected to the cocks 53 and 54, respectively.

As shown in FIG. 1, the spinal cord removing apparatus 1 is equipped with the nozzle sterilization container 5, which serves to sterilizes the first and second nozzles 3 and 4 after suctioning and removing the spinal cord. Typically, boiling water is filled into the nozzle sterilization container 5 for sterilization. Alternatively, disinfectant permitted to be added to food may be added to the nozzle sterilization container 5, or sterilization may be conducted by irradiation.

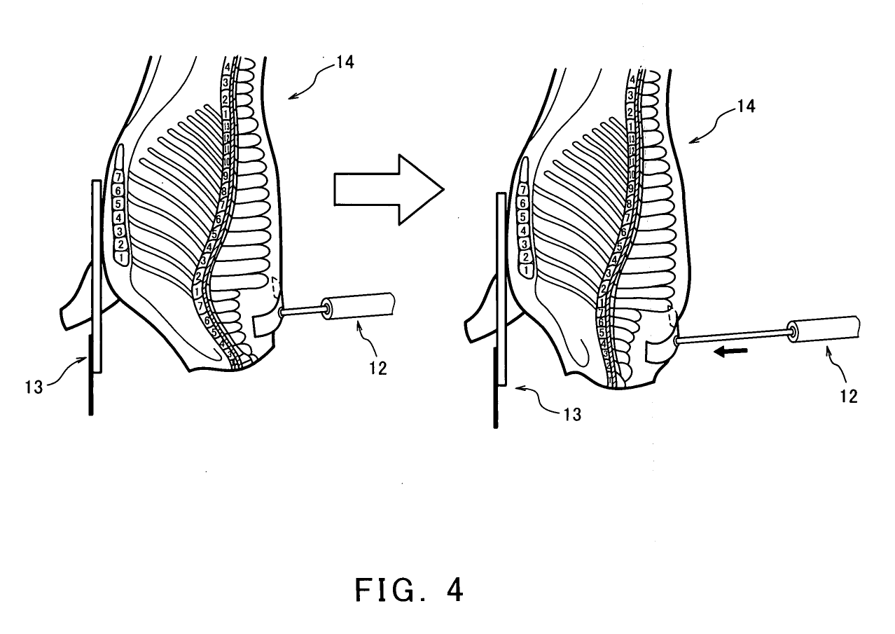

In some of the beef cattle to be treated, the spinal column is significantly curved in a way that an angle made between the cervical vertebrae 141 and the thoracic vertebrae 142 is below 70 to 80 degrees. Therefore, when the first nozzle 3 is inserted to suction and remove the spinal cord, the first nozzle 3 is sometimes difficult to advance at a position represented by b in FIG. 2, immediately before the thoracic vertebrae 142. As shown in FIG. 4, the press member 12 and the support member 13 desirably press the curved spinal column to substantially straighten the same so that the angle made between the cervical vertebrae 141 and thoracic vertebrae 142 becomes within a range of about 140 to 160 degrees. More specifically, the support member 13 supports a thoracic part of the carcass 14 and the press member 12 presses a head side of a dorsal part of the carcass 14 under a pressure of, preferably 0.1 to 0.2 Mpa. This may be done manually or by using a press system using a hydraulic cylinder or the like. As used herein, the head side corresponds to a vicinity of a tail side of the cervical vertebrae 141 (see FIGS. 2 and 4).

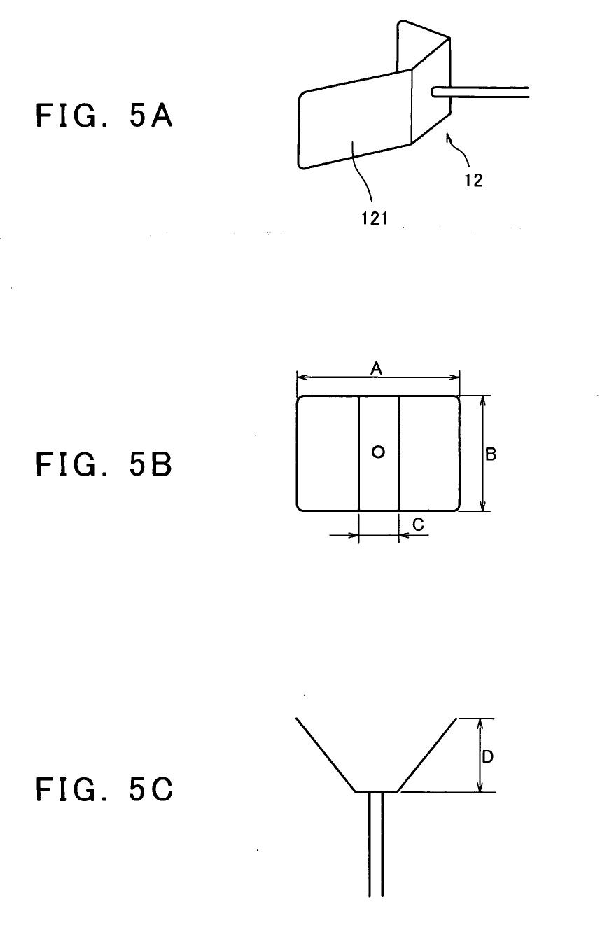

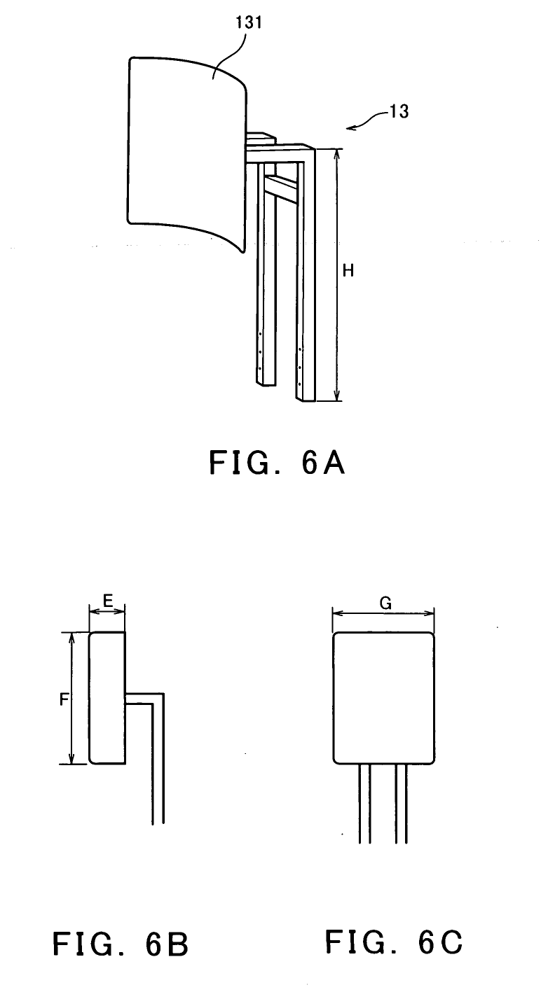

The press member 12 is shown in FIGS. 5A, 5B, and 5C, and the support member 13 is shown in FIGS. 6A, 6B and 6C. The press member 12 is comprised of a press plate 121 having a shape in FIG. 5A and a bar attached to the press plate 121. The bar may be slidable backward and forward. FIG. 5B and FIG. 5C are a rear view and a plan view of the press plate 121. The desirable size of the press plate 121 is such that A is 16 cm, B is 12 cm, C is 4 cm, and D is 5.5 cm. As shown in FIG. 6A, the support member 13 is structured such that a support plate 131 as a curved plate is attached to a column. FIGS. 6B and 6C are a side view and a front view of the support plate 131. The desirable size of the support plate 131 for pressing the beef cattle is such that E is 6 cm, F is 53 cm, G is 36 cm, and height H of the column is 130 cm. Designs of the press plate 121 and the support plate 131 may be changed in various ways provided that the press member 121 and the support plate 131 respectively conform in shape to a part of the carcass 14 to be pressed and a part of the carcass 14 to be supported and apply a proper pressure to them. The press plate 121 and the support plate 131 are desirably a stainless plate having a thickness of about 2 mm, but are not intended to be limited to this so long as they have proper strength and durability.

Subsequently, the suction unit 2 connected to the first and second nozzles 3 and 4, will be described. The first and second nozzles 3 and 4 are connected to the vacuum pipe 6 forming the suction unit 2 through the cocks 53 and 54, respectively. A terminal end of the vacuum pipe 6 is connected to the vacuum pump 9 capable of applying a negative pressure of 1 to 30 in Hg. An exhaust gas is discharged to outside. The meter 10 is installed on the vacuum pipe 6 to monitor a pressure within the pipe 6. The meter 10 makes it possible to check whether or not the negative pressure in the first and second steps are proper. A vacuum tank 7 is installed on the vacuum pipe 6 to separate the suctioned spinal cord and collect it into the collecting container 15. Further, for maintenance of the vacuum pump 9, a vacuum filter 8 is installed downstream of the vacuum tank 7 to completely inhibit liquid and objects from entering the vacuum pump 9. The structure of the suction unit 2 may be suitably altered in various ways so long as the conventionally known suction unit is suitably used to completely suction the spinal cord at a proper negative pressure.

A cloth filter or the like is provided in the collecting container 15 into which the spinal cord suctioned and removed by the suction unit 2 is collected. After suctioning the spinal cord in the first and second steps, the collected spinal cord is incinerated.

The carcass from which the spinal cord has been removed in the manner described above go through the process: splitting the dorsal part, perfectly removing dura mater adhering to an interior of the spinal column, cleaning and sterilizing the carcass, and producing dressed carcass, which is shipped as beef cattle.

The above method can be applied to beef cattle of various sizes or cattle other than the beef cattle such as pig and sheep, by adjusting the size of the nozzles, the negative pressure, and the like. When the above method is applied to cattle having a relatively small size and having a fixed inner diameter of the spinal cavity, suction and removal of the spinal cord can be accomplished in the first step without a need for the two types of nozzles.

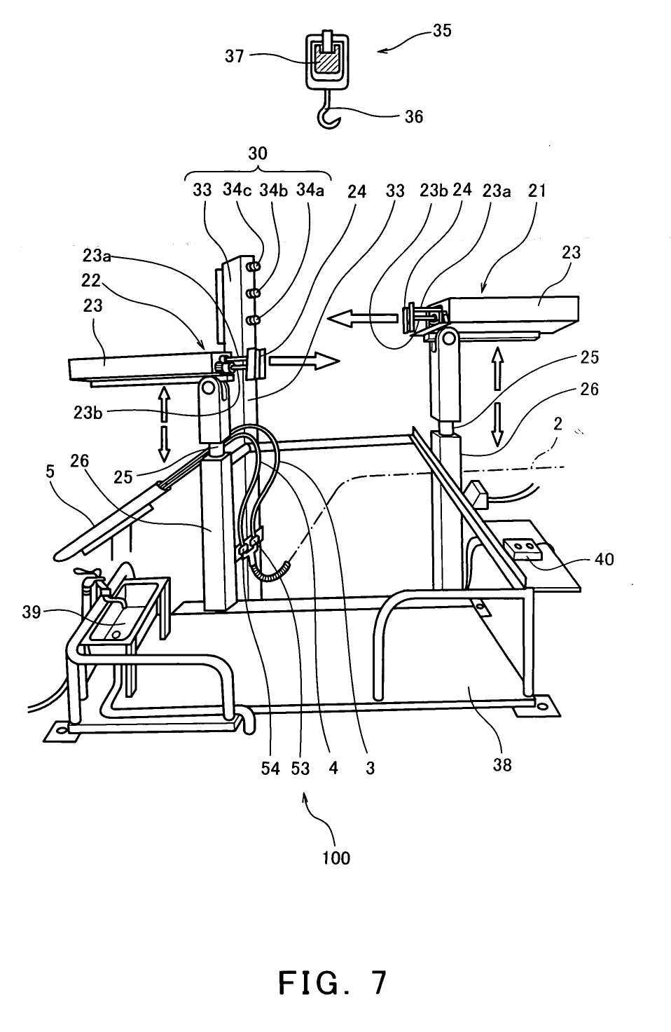

FIG. 7 shows a spinal cord removing apparatus 100 according to another embodiment. The apparatus 100 in FIG. 7 is configured to insert the suction nozzles 3 and 4 into the spinal cavity of the carcass to suction and remove the spinal cord. Typically, the nozzles 3 and 4 are inserted into the spinal cavity from the direction of a neck side of the spinal column of the carcass. The apparatus 100 comprises a pair of first and second pressers 21 and 22. The first presser 21 serves to press a thoracic part of a carcass of the slaughtered cattle (simply referred to as the carcass) and the second presser 22 serves to press a dorsal part of the carcass. In each of the pressers 21 and 22, a hydraulic cylinder or a pneumatic cylinder, or a screw rod rotated by a motor is used as a drive unit 23. A press plate 24 having a shape conforming to the surface of the carcass is attached to a tip end of an output shaft 23a of the drive unit 23, and is brought into contact with the carcass. A guide rod 23b is provided in parallel with the output shaft 23a to guide advancement and retraction of the output shaft 23a. The pressers 21 and 22 serve to substantially straighten curved spinal column inherent to the carcass to allow the suction nozzles 3 and 4 to be smoothly inserted.

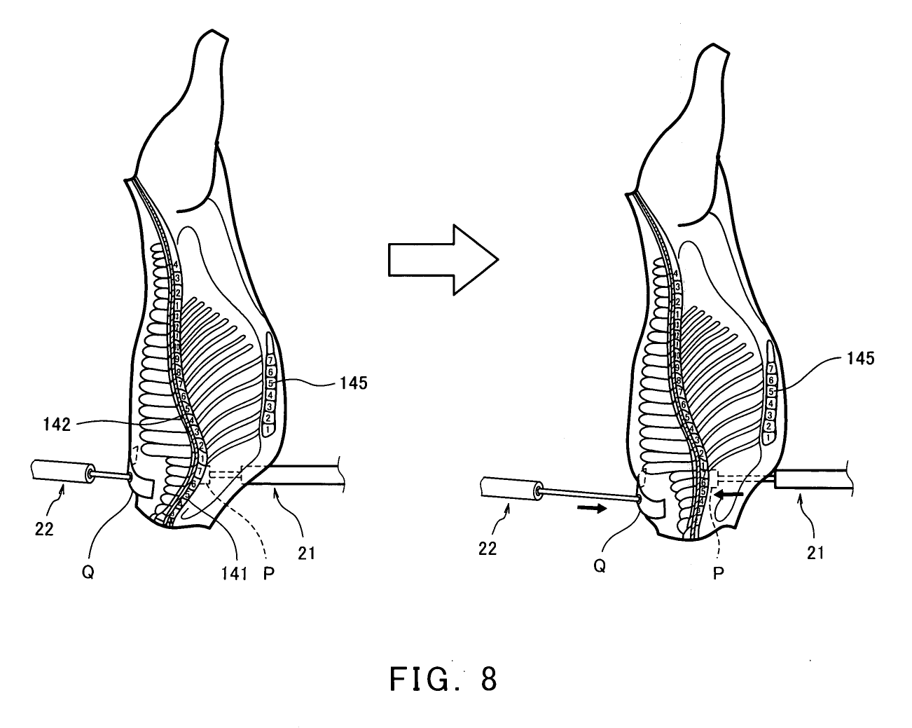

As described above, the spinal column of some of the beef cattle is greatly curved from the cervical vertebrae 141 to the thoracic vertebrae 142. So, when the nozzles 3 and 4 are inserted into the spinal cavity, the pressers 21 and 22 press the curved spinal column so that an angle made between the cervical vertebrae 141 and the thoracic vertebrae 142 becomes in a range of about 140 to 160 degrees. As shown in FIG. 8, specifically, the first presser 21 presses a thoracic side of the cervical vertebrae 141 of the carcass, i.e., a part (P in FIG. 8) in the vicinity of a boundary between the cervical vertebrae 141 and the thoracic vertebrae 142, and the second presser 22 presses the head side part (Q in FIG. 8) on the dorsal side of the carcass, under a pressure of, preferably, 0.1 to 0.2 Mpa. The first presser 21 is inserted from the thoracic part of the carcass cut out shown in FIG. 8 into the spinal cavity. Alternatively, the first presser 21 may press sternal vertebrae 145 from outer side as desired.

As shown in FIG. 7, the pressers 21 and 22 are attached on columnar supports 26 each containing an up-down unit 25 such as a hydraulic cylinder, a pneumatic cylinder, or a screw rod rotated by a motor. The up-down units 25 serve to move the pressers 21 and 22 up and down. The pressers 21 and 22 are attached on the columnar supports 26 so as to be vertically pivotable. The pressers 21 and 22 are fixed so that press plates 24 advance in a direction to form a desired angle with respect to a horizontal plane. This construction can change press direction depending on the shape of the carcass. This pivot and fixing mechanisms may be those known in the art. Alternatively, only one of the first and second pressers 21 and 22 may be equipped with the up-down and pivot mechanism. In another alternative example, the press plates 24 may be adapted to advance in a fixed direction by omitting the pivot mechanism.

The apparatus 100 is equipped with first and second nozzles 3 and 4 that are inserted into the spinal cavity of the carcass to suction and remove the spinal cord. The first and second nozzles 3 and 4 are identical to those (see FIG. 3). The first nozzle 3 has a large diameter and the second nozzle 4 has a small diameter. In the manner as described above, first, the first nozzle 3 is inserted into the spinal cavity of the carcass in the range from the head side to a vicinity of the sixth lumbar vertebra (represented by M in FIG. 3A) while suctioning the spinal cord. Then, the first nozzle 3 is pulled out, and the second nozzle 4 is inserted to the sacral vertebrae (represented by N in FIG. 3A) while suctioning the spinal cord within the spinal cavity. In this way, two types of nozzles 3 and 4 are used in two steps, respectively.

The first and second nozzles 3 and 4 are connected to the suction unit 2 through the cocks 53 and 54, respectively. The cocks 53 and 54 serve to perform switching of a suction path between the nozzles 3 and 4 and stop suction of the nozzles 3 and 4. In addition, the apparatus 100 is equipped with the sterilization container 5 for sterilizing the nozzles 3 and 4.

Further, the apparatus 100 is equipped with a detector 30 configured to detect the size of the carcass. The detector 30 is provided with a plurality of detecting portions 34 aligned on a columnar support 33 in the vertical direction in the following order from below: a large-sized carcass detecting portion 34a, a medium-sized carcass detecting portion 34b, and a small-sized carcass detecting portion 34c. In the present invention, the number of the detecting portions is not intended to be limited to this. In order to classify the size of carcass into more categories, four or more detecting portions may be aligned on the columnar support 33 in the vertical direction.

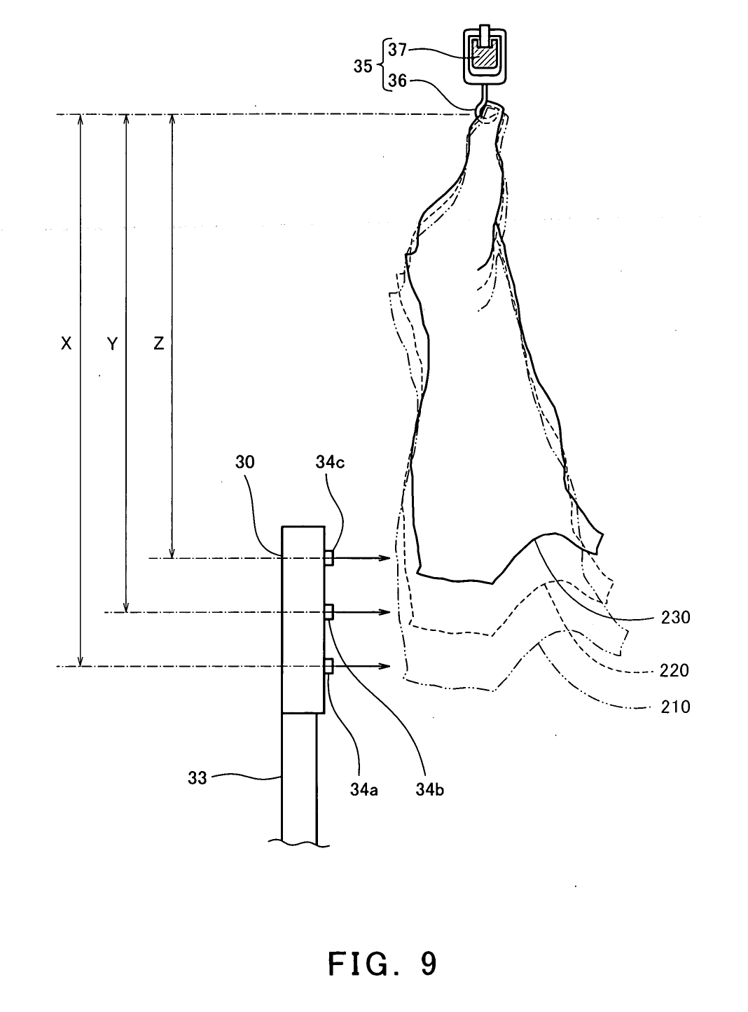

As shown in FIG. 9, the size of the carcass is detected by the detector 30 as described below. The apparatus 100 is equipped with a moving device 35 for carrying the suspended carcass to a treatment area. The moving device 35 has a hook 36 with which a part of the suspended carcass is engaged with, and a rail 37 that guides movement of the hook 36. And, the size of the carcass is detected by utilizing a difference between a vertical position of the hook 3 and vertical position of the detecting portion 34a, 34b, or 34c in the treatment area.

For example, in the case of the beef cattle, a distance X between the hook 36 and the large-sized detecting portion 34a is about 265 cm, a distance Y between the hook 36 and the medium-sized detecting portion 34b is about 250 cm, and a distance Z between the hook 36 and the small-sized carcass detecting portion 34c is about 235 cm. The detecting portions 34a to 34c are provided with, for example, photoelectric sensors. When all of the detecting portions 34a, 34b, and 34c detect the presence of a carcass 210, it is judged that the carcass 210 is large-sized. When the medium-sized detecting portion 34b and the small-sized detecting portion 34c detect the presence of a carcass 220, it is judged that the carcass 220 is medium-sized. When the small-sized carcass 34 detects the presence of a carcass 230, it is judged that the carcass 230 is small-sized. The detector 30 is configured to adjust vertical positioning of the detecting portions 34a, 34b or 34c integrally with the columnar support 33 by extending or retracting the columnar support 33. Also, a distance between the detecting portions 34a and 34b or between the detecting portions 34b and 34c may be easily variable. By doing so, detection range of the size of the carcass is variable.

Upon detecting the size of the carcass, the detector 30 outputs a signal. In response to this, the pressers 21 and 22 are automatically moved up and down (in general, up) to a proper position for the carcass. The pressers 21 and 22 press proper parts of the carcass shown in FIG. 3 to suitably straighten the curved spinal column. After the operation, the pressers 21 and 22 move downward to their initial positions. The moving distance of the pressers 21 and 22 is predetermined based on the vertical position of the hook 36 and the part of the carcass (FIG. 8) to be pressed of detected size (large, medium or small).

The above-described members or devices are mounted on a work table 38 shown in FIG. 7, except the moving device 35 of the carcass. It should be appreciated that the sterilization container 5 may be installed at a distance apart from the work table 38 for the safety of the operator when high-temperature water or high-temperature steam is used as a sterilizer. In addition to the above-described members and devices, a hand washing container 39 for an operator to wash his/her hands, and an operation unit 40 for fine adjustment of the vertical positions of the pressers 21 and 22 are mounted on the work table 38. The operation unit 40 is configured to drive the up-down devices 25 to allow the pressers 21 and 22 to move up and down by a minute distance by a pushing operation of an up-button or a down-button by the operator. In this embodiment, while the operator is pushing the up-button, the up-down device 25 operates.

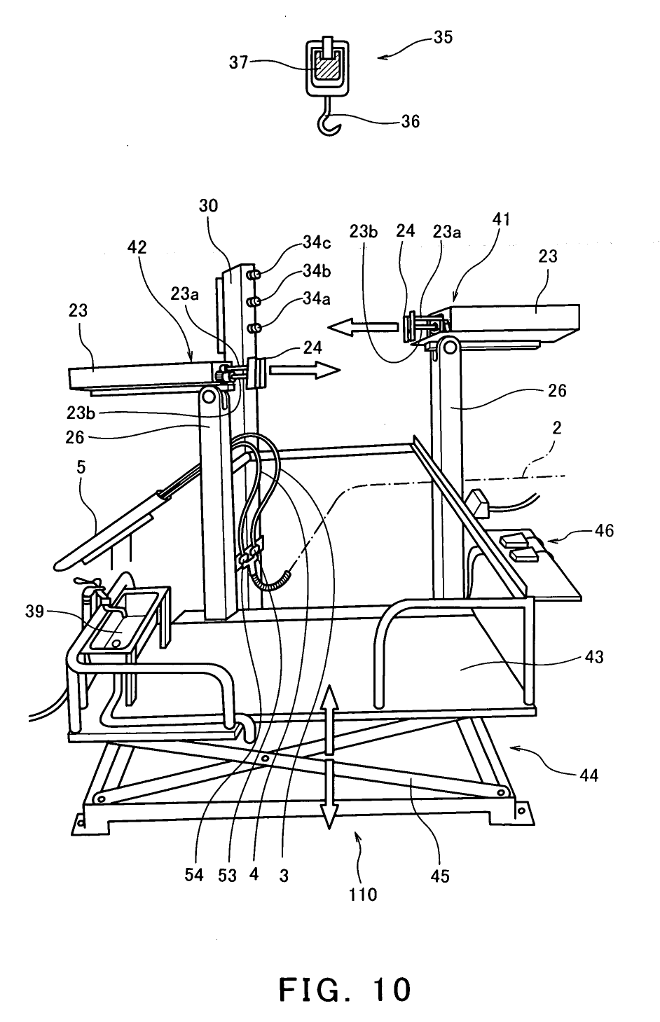

With reference to FIG. 10, a spinal cord removing apparatus (simply referred to as an apparatus) 110 is substantially identical in construction to the apparatus 100 in FIG. 7 except that, the pressers 21 and 22 of the apparatus 100 in FIG. 7 are configured to move up and down, while in the apparatus 110, a work table 43, rather than pressers 41 and 42, is configured to move up and down. Specifically, the work table 43 is installed on a floor with an up-down device 44 disposed between the floor and the table 43. The up-down device 44 is configured such that an arm 45 formed by a plurality of rod members combined in the form of pantograph is vertically extendable and retractable by a drive unit comprised of a hydraulic cylinder, or a screw rod rotated by a motor (not shown).

And, the detector 30 detects the size of the carcass. In response to the signal from the detector 30, the up-down device 44 automatically moves the work table 43 up and down. The work table 43 is moved up and down to a position where the pressers 41 and 42 can press proper parts of the carcass to suitably straighten the curved spinal column. The moving distance of the work table 43 is predetermined based on the distance between a vertical position of the hook 36 and the part (FIG. 8) of the carcass to be pressed of the detected size (large, medium, or small).

Since the work table 43 itself moves up and down as described above, the detector 30 is installed on the moveless floor, rather than the work table 43. And, an operation unit 46 is mounted on the work table 43 to allow the operator to perform fine adjustment of the vertical position of the work table 43. The operation unit 46 is configured to drive the up-down device 44 to cause the work table 43 to move up and down by a minute distance by an pushing operation of an up-button or a down-button by the operator. In this embodiment, while the operator is pushing the button, the drive unit of the up-down device 44 operates.

Other than the above-described configuration, the apparatus 110 is substantially identical in construction to the apparatus 100 in FIG. 7. Therefore, in FIG. 10, the same reference numerals as those in FIG. 7 are used to identify the same or corresponding parts, which will not be further described.

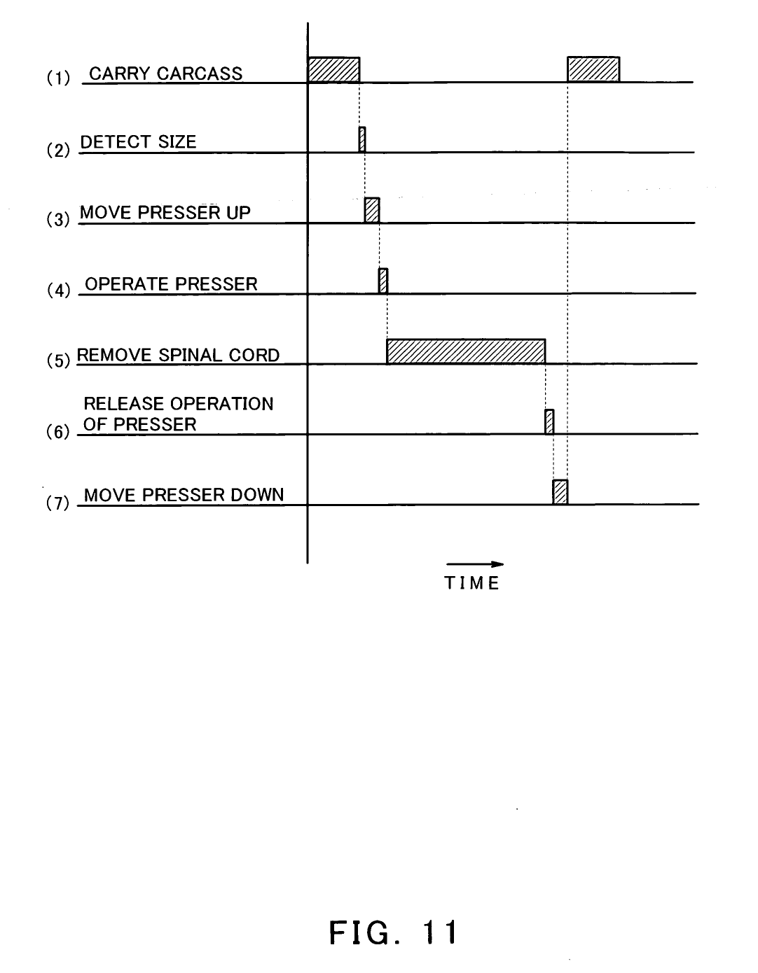

FIG. 11 is a time chart showing an example of a process of removing the spinal cord from the carcass of the beef cattle by using any of the apparatus 100 and 110. In description below, members or devices are referenced by the reference numerals in FIG. 7. First of all, (1) the carcass is engaged with the hook 36 to be suspended, and the moving device 35 carries the carcass onto the work table 38. (2) Then, the detector 30 detects the size of the carcass. (3) In response to a detection signal, the pressers 21 and 22 move upward. (4) The pressers 21 and 22 operate to substantially straighten the curved spinal column. (5) The operator inserts the nozzles 3 and 4 into the spinal cavity of the carcass to remove the spinal cord. (6) The pressing operations of the pressers 21 and 22 are released. Or this is done by an operation of the operator. (7) The pressers 21 and 22 move downward to their initial positions. The above operations are repeated. After the operation in (5), the operator inserts the nozzles 3 and 4 into the sterilization container 5 for sterilization.

Time required for the process (1 cycle) of treating the carcass of one cattle is about 2 to 3 minutes. In detail, the step (1) requires about thirty seconds, the step (2) requires about zero second, the step (3) requires about five seconds, the step (4) requires about two seconds, the step (5) requires about 105 seconds, the step (6) requires about 2 seconds, and the step (7) requires about five seconds. These are only illustrative. As should be appreciated, the treatment time is significantly reduced in contract to the conventional example.

The work tables 38 and 43 may be adapted to be carried for the sake convenience. This may be achieved by, for example, attaching wheels on the work tables 38 and 43. By doing so, for example, the spinal cord removing apparatus can be guided along the rail 37 of the moving device 35 and placed at a proper position. Thus, flexibility of placement can be increased.

Numerous modifications and alternative embodiments of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention and all modifications which come within the scope of the appended claims are reserved.

1. A method of removing spinal cord, comprising the step of:
after letting a carcass of slaughtered cattle bleed, removing a tail part from the carcass, cutting off a head from the carcass, and tearing off skin from the carcass,
removing the spinal cord from a spinal cavity by inserting a suction nozzle from a head side of the carcass into the spinal cavity to suction the spinal cord within the spinal cavity.

2. The method according to claim 1, wherein the cattle is beef cattle, and the step of removing the spinal cord includes:
a first step of inserting a first suction nozzle to a terminal end part of a tail side of lumbar vertebrae to suction the spinal cord; and
a second step of inserting a second suction nozzle to a terminal end part of a tail side of sacral vertebrae to suction the spinal cord, the second suction nozzle having an outer diameter smaller than an outer diameter of the first suction nozzle.

3. The method according to claim 1, further comprising the step of:
substantially straightening a spinal column of said cattle by pressing the head side of the carcass to reduce a curvature of the spinal column, when the suction nozzle is inserted into the spinal cavity.

4. The method according to claim 3, wherein the step of substantially the straightening spinal column is performed by using a press member and a support member.

5. An apparatus for removing spinal cord comprising:
a suction nozzle adapted to be inserted into a spinal cavity of a carcass of slaughtered cattle to suction spinal cord within the spinal cavity.

6. The apparatus according to claim 5, further comprising:
to allow the suction nozzle to be inserted into the spinal cavity of the carcass of the slaughtered cattle,
a press member configured to press a head side of a dorsal part of the carcass to reduce a curvature of spinal column; and
a support member configured to support a thoracic part of the carcass.

7. The apparatus according to claim 7, wherein the suction nozzle includes a first nozzle and a second nozzle, and the first nozzle is larger in diameter than the second nozzle.

8. The apparatus according to claim 7, wherein the first suction nozzle has an outer diameter of 14 mm and the second suction nozzle has an outer diameter of 11 mm.

9. The apparatus according to claim 5, further comprising:
a detector configured to detect a size of the carcass of the slaughtered cattle;
a first presser configured to press one of the dorsal part and the thoracic part of the carcass of the slaughtered cattle; and
a second presser configured to press the other part of the carcass of the slaughtered cattle, wherein
at least one of the first and second pressers is movable up and down.

10. The apparatus according to claim 9, wherein at least one of the first and second pressers is movable relative to the carcass along a length of the carcass.

11. The apparatus according to claim 9, further comprising:
a suspension device configured to suspend the carcass of the slaughtered cattle, the suction device having a holding portion adapted to hold the carcass of the slaughtered cattle, wherein the detector has a plurality of detecting portions respectively provided at positions spaced predetermined distances apart from the holding portion.

12. The apparatus according to claim 9, wherein at least one of the first and second pressers is vertically pivotable to vary a press direction.

13. The apparatus according to claim 9, wherein at least one of the first and second pressers is configured to, in response to a detection signal detected by the detector, move up and down by a distance corresponding to the detection signal.

14. The apparatus according to claim 9, wherein a vertical position of at least one of the first and second pressers is adjustable by an operation performed by an operator.

15. The apparatus according to claim 5, further comprising:
a detector configured to detect a size of the carcass of the slaughtered cattle;
a first presser configured to press one of the dorsal part and the thoracic part of the carcass of the slaughtered cattle;
a second presser configured to press the other part; and
an up and down work table on which the first and second pressers are mounted.

16. The apparatus according to claim 15, wherein the work table is configured to, in response to the detection signal detected by the detector, move up and down by a distance corresponding to the detection signal.

17. The apparatus according to claim 15, wherein a vertical position of the work table is adjustable by an operation performed by an operator.

18. The apparatus according to claim 15, wherein at least one of the first and second pressers is movable relative to the carcass along a length of the carcass.

19. The apparatus according to claim 15, further comprising:
a suspension device configured to suspend the carcass of the slaughtered cattle, the suction device having a holding portion adapted to hold the carcass of the slaughtered cattle, wherein the detector has a plurality of detecting portions respectively provided at positions spaced predetermined distances apart from the holding portion.

20. The apparatus according to claim 15, wherein at least one of the first and second pressers is vertically pivotable to vary a press direction.

21. The method of claim 1, further comprising the step of:
collecting the spinal cord suctioned and removed from the spinal cavity by the suction nozzle into a collecting container connected to the suction nozzle.

22. The apparatus according to claim 5, further comprising:
a suction unit connected to the suction nozzle, the suction unit including a vacuum tank configured to separate the removed spinal cord and a collecting container configured to collect the separated spinal cord.
